(19) United States
(12) Patent Application Publication
(10) Pub. No.: US 2025/0382557 A1
(43) Pub. Date: Dec. 18, 2025

(54) METHOD FOR PRODUCING A BEVERAGE WITH LIGHT

(71) Applicant: SUNTORY HOLDINGS LIMITED, Osaka (JP)

(72) Inventors: Joseph Michael Batcheldor, Clermont, KY (US); Andrew Paul Yourick, Clermont, KY (US)

(73) Assignee: SUNTORY HOLDINGS LIMITED, Osaka (JP)

(21) Appl. No.: 19/237,406

(22) Filed: Jun. 13, 2025

Related U.S. Application Data
(60) Provisional application No. 63/660,200, filed on Jun. 14, 2024.

(51) Int. Cl. C12H 1/16; B01D 3/00; C12G 3/021

(52) U.S. Cl. CPC C12H 1/165; B01D 3/003; C12G 3/021

(57) ABSTRACT

An improved process for producing beverage having favorable sensory characteristic such as smell, taste, etc. The process comprises irradiating the liquid with a light with a dose of 1-watt hours per litre to 3,000-watt hours per litre for 1 hour to 96 hours at a temperature of between 15° C. and 55° C. The process improves the taste of the beverage.

This application claims priority from U.S. Patent Application No. 63/660,200 filed on Jun. 14, 2024, the contents and elements of which are herein incorporated by reference for all purposes.

### FIELD

The present invention relates to the field of beverages. More particularly, the processes disclosed herein relate to methods of manufacturing beverages to improve taste.

### BACKGROUND

There are beverage products with many kinds of ingredients, manufactured through many kinds of process. Some beverages products are known to contain certain flavor profiles, and particularly desirable to certain customers through the improvement.

### SUMMARY OF THE INVENTION

Some liquid just after mixture of varieties of ingredients do not have favorable tastes and flavors.

There is provided a novel method for processing liquids to manufacture beverages with favorable taste and flavors. The process comprises: irradiating a liquid with a light with a dose of 50-watt hours per litre to 3,000-watt hours per litre for 1 hour to 96 hours at a temperature of between 15° C. and 55° C.

Other features and aspects of the disclosure are described in detail below and may be contemplated by those of ordinary skill in the art.

### BRIEF DESCRIPTION OF THE FIGURES

FIG. 1 shows the spectra peak of various lights.

FIG. 2 shows an illustration of the system to carry out the process in accordance with the invention in one embodiment.

### DETAILED DESCRIPTION

The various aspects and embodiments are described herein. These aspects and embodiments may, however, be embodied in many different forms and should not be construed as limitations.

Headings included herein are simply for ease of references.

### A. Definitions

The use of individual numerical values can be construed as approximations as if the stated values are preceded by the word “about” or “approximately.” As one embodiment, the stated value in this specification can be construed as an approximate after rounding off.

The term “liquid” in this application may mean a liquid before the irradiation, unless otherwise specified.

### B. Fermentation Process

Although specific examples are not described herein, the fermentation step may be performed under particularly general conditions and is not limited.

### C. Distillation Process

The mash may comprise water, and at least one flavor grains, including rye, barley, wheat, rice, other grains, malts and any combination thereof.

Process with Light Irradiation

In one embodiment, a liquid for beverages such as distillates obtained from the grain raw materials may include unpleasant flavors. The unpleasant flavors may be due to sulfur-containing compounds.

In one embodiment, the process comprises irradiating the liquid with a light with a dose of 50-watt hours per litre to 3,000-watt hours per litre for 3 hours to 96 hours at a temperature of between 15° C. and 55° C. In one embodiment, the process comprises irradiating the liquid with a light with a dose of 50-watt hours per litre to 3,000-watt hours per litre for 1 hours to 96 hours at a temperature of between 15° C. and 55° C.

In another embodiment, the process comprises: (a) providing the liquid comprising ethanol and one or more sulfur-containing compounds, wherein the one or more sulfur-containing compounds provides an initial total sulfur content. The process further comprising (b) maintaining the liquid at a temperature of between 15° C. and 55° C. The process further comprising (c) irradiating the liquid with a light having an energy peak at a wavelength of 315 nm and 400 nm for a period of between 3 and 96 hours. Upon completion of irradiation, the total sulfur content of the beverage can be reduced to between 10% and 90% of the initial total sulfur content. In another embodiment, the process comprises: (a) providing the liquid comprising ethanol and one or more sulfur-containing compounds, wherein the one or more sulfur-containing compounds provides an initial total sulfur content. The process further comprising (b) maintaining the liquid at a temperature of between 15° C. and 55° C. The process further comprising (c) irradiating the liquid with a light having an energy peak at a wavelength of 315 nm and 400 nm for a period of between 1 and 96 hours. Upon completion of irradiation, the total sulfur content of the beverage can be reduced to between 10% and 90% of the initial total sulfur content.

In another embodiment, the process comprises: (a) providing the liquid comprising ethanol and one or more sulfur-containing compounds, wherein the one or more sulfur-containing compounds provides an initial total sulfur content. The process further comprises (b) maintaining the liquid at a temperature of between 15° C. and 55° C. The process further comprises (c) irradiating the liquid with a light that has an energy peak at a wavelength of 315 nm and 400 nm for a period of between 8 and 56 hours.

In another embodiment, the process comprises: (a) providing the liquid comprising ethanol and one or more sulfur-containing compounds, wherein the one or more sulfur-containing compounds provides an initial total sulfur content. The process further comprises (b) maintaining the liquid at a temperature of between 15° C. and 55° C. The process further comprises (c) irradiating the liquid with a light that has an energy peak at a wavelength of 315 nm and 400 nm for a period of between 8 and 56 hours.

In another embodiment, the process comprises: (a) providing the liquid comprising ethanol and one or more sulfur-containing compounds, wherein the one or more sulfur-containing compounds provides an initial total sulfur content. The process further comprises (b) maintaining the liquid at a temperature of between 15° C. and 55° C. The process further comprises (c) irradiating the liquid with a light that has an energy peak at a wavelength of 315 nm and 400 nm for a period of 32 hours.

In another embodiment, the process comprises: (a) providing the liquid comprising ethanol and one or more sulfur-containing compounds, wherein the one or more sulfur-containing compounds provides an initial total sulfur content. The process further comprises (b) maintaining the liquid at a temperature of between 15° C. and 55° C. The process further comprises (c) irradiating the liquid with a light that has an energy peak at a wavelength of 315 nm and 400 nm for a period of 32 hours.

In some embodiments, the sulfur-containing compound can be one compound, or two or more. The sulfur-containing compound can be chosen from alkyl sulfides, thiols, methylthio group compounds, thiophenes, dithiapentane derivatives, and furfuryl compounds, and any combination thereof.

In some embodiments, the sulfur-containing compound can include dimethyl sulfide, diethyl sulfide, dipropyl sulfide, methyl propyl sulfide, dipropyl disulfide, iso-butyl methyl disulfide, dimethyl trisulfide, 2-(methylthio) ethanol, 3-(methylthio) propanol, 3-(methylthio) propanal, 3-(methylthio) propyl acetate, S-methyl thioacetate, 3,4-dithiapentyl alcohol, 3,4-dithiapentyl ethyl ether, 3,4-dithiapentyl acetate, methyl-(2-methyl-3-furyl) disulfide, hydrogen sulfide, methanethiol, ethanethiol, thiophene, 2-methylthiophenone, 2,5-dimethylthiophene, thiophene-2-carboxaldehyde, thiophene-3-carboxaldehyde, 3-methylthiophene-2-carboxaldehyde, 3-ethylthiophene-2-carboxaldehyde, 5-methylthiophene-2-carboxaldehyde, dihydro-2-methyl-3(2H)-thiophenone, 2-acetyl thiophene, 2-butanoyl thiophene, 2-acetyl-5-methyl thiophene, 1-benzothiophene, 1,3-thiazole, 2-methyl-1,3-thiazole, 2-acetyl-1,3-thiazole, 4-methyl-5-vinyl-1,3-thiazole, 1,3-benzothiazole, 2-methyl-1,3-benzothiazole, 3-ethyl-1,3-benzothiazolethione, or 2-(2-furanyl)-thiazole, carbonyl sulfide and any combination thereof.

In one embodiment, the process comprises: (a) providing the liquid comprising ethanol and di-methyl sulfide, in which the liquid provided has an initial total sulfur content. The process further comprises (b) maintaining the liquid at a temperature of between 20° C. and 55° C. The process further comprises (c) irradiating the liquid with UV-A light for a period of between 3 and 96 hours. Upon completion of irradiation, the di-methyl sulfide content of the liquid can be reduced to between 10% and 90% of the initial di-methyl sulfide content.

In one embodiment, the process comprises: (a) providing the liquid comprising ethanol and di-methyl sulfide, in which the liquid provided has an initial total sulfur content; (b) maintaining the liquid at a temperature of between 15° C. and 55° C.; and (c) irradiating the liquid with UV-A light for a period of between 8 and 56 hours. Upon completion of irradiation, the di-methyl sulfide content of the liquid can be reduced to between 80% and 90% of the initial di-methyl sulfide content.

In one embodiment, the process comprises: (a) providing the liquid comprising ethanol and di-methyl sulfide, in which the liquid provided has an initial total sulfur content; (b) maintaining the liquid at a temperature of between 15° C. and 55° C.; and (c) irradiating the liquid with UV-A light for a period of between 8 and 56 hours. Upon completion of irradiation, the di-methyl sulfide content of the liquid can be reduced to at least 85% of the initial di-methyl sulfide content.

In one embodiment, the process comprises: (a) providing the liquid comprising ethanol and di-methyl sulfide, in which the liquid provided has an initial total sulfur content; (b) maintaining the liquid at a temperature of between 15° C. and 55° C.; and (c) irradiating the liquid with UV-A light for a period of 32 hours. Upon completion of irradiation, the di-methyl sulfide content of the liquid can be reduced to between 80% and 90% of the initial di-methyl sulfide content.

In one embodiment, the process comprises: (a) providing liquid the liquid comprising ethanol and di-methyl sulfide, in which the liquid provided has an initial total sulfur content; (b) maintaining the liquid at a temperature of between 15° C. and 55° C.; and (c) irradiating the liquid with UV-A light for a period of 32 hours. Upon completion of irradiation, the di-methyl sulfide content of the liquid can be reduced to 80-85% of the initial di-methyl sulfide content.

In one embodiment, the process comprises: (a) providing the liquid comprising ethanol and hydrogen sulfide, in which the liquid provided has an initial total sulfur content; (b) maintaining the liquid at a temperature of between 15° C. and 55° C.; and (c) irradiating the liquid with UV-A light for a period of between 6 and 96 hours. Upon completion of irradiation, hydrogen sulfide content of the liquid can be reduced to between 10% and 90% of the initial hydrogen sulfide content.

In one embodiment, the process comprises: (a) providing the liquid comprising ethanol and hydrogen sulfide, in which the liquid provided has an initial total sulfur content; (b) maintaining the liquid at a temperature of between 15° C. and 55° C.; and (c) irradiating the liquid with UV-A light for a period of between 8 and 56 hours. Upon completion of irradiation, hydrogen sulfide content of the liquid can be reduced to between 10% and 90% of the initial hydrogen sulfide content.

In one embodiment, the process comprises: (a) providing the liquid comprising ethanol and hydrogen sulfide, in which the liquid provided has an initial total sulfur content; (b) maintaining the liquid at a temperature of between 15° C. and 55° C.; and (c) irradiating the liquid with UV-A light for a period of 32 hours. Upon completion of irradiation, hydrogen sulfide content of the liquid can be reduced to between 10% and 90% of the initial hydrogen sulfide content.

In one embodiment, the process comprises: (a) providing the liquid comprising ethanol and sulfur dioxide, in which the liquid provided has an initial total sulfur content; (b) maintaining the liquid at a temperature of between 15° C. and 55° C.; and (c) irradiating the liquid with UV-A light for a period of between 6 and 96 hours. Upon completion of irradiation, sulfur dioxide content of the liquid can be reduced to between 10% and 90% of the initial sulfur dioxide content.

In one embodiment, the process comprises: (a) providing the liquid comprising ethanol and sulfur dioxide, in which the liquid provided has an initial total sulfur content; (b) maintaining the liquid at a temperature of between 15° C. and 55° C.; and (c) irradiating the liquid with UV-A light for a period of between 8 and 56 hours. Upon completion of irradiation, sulfur dioxide content of the liquid can be reduced to between 10% and 90% of the initial sulfur dioxide content.

In one embodiment, the process comprises: (a) providing the liquid comprising ethanol and sulfur dioxide, in which the liquid provided has an initial total sulfur content; (b) maintaining the liquid at a temperature of between 15° C. and 55° C.; and (c) irradiating the liquid with UV-A light for a period of 32 hours. Upon completion of irradiation, sulfur dioxide content of the liquid is reduced to between 10% and 90% of the initial sulfur dioxide content.

In certain embodiments, the method further comprising adding a flavorant to the liquid. In certain embodiments, the flavorant comprises charred and/or toasted wood staves having a surface to volume ratio of between 45 to 95 square inches per gallon of liquid.

In certain embodiments, the liquid is maintained in the presence of the flavorant at a temperature of between 20° C. and 55° C. for a period of 1 day to 2 weeks to provide a flavored beverage.

In certain embodiments, the process further comprises an oxidizing step. In one embodiment, the oxidizing step comprises an ozone purge. In one embodiment, the oxidizing step comprises an air purge. In one embodiment, the oxidizing step comprises an agitation. In one embodiment, the oxidizing step comprises a combination of any one of an ozone purge, an air purge, or an agitation.

In one embodiment, the liquid can be irradiated with UV-A light with an exposure of between 50-watt hours per litre and 3,000-watt hours per litre. In another embodiment, the liquid can be irradiated with UV-A light with an exposure of between 100-watt hours per litre and 2,500-watt hours per litre.

For example, it is preferable that the liquid can be irradiated with UV-A light with an exposure of 3-watt hours per litre or more, 5-watt hours per litre or more, 10-watt hours per litre or more, 15-watt hours per litre or more, 20-watt hours per litre or more, 30-watt hours per litre or more, 40-watt hours per litre or more, 50-watt hours per litre or more, 60-watt hours per litre or more, 70-watt hours per litre or more, 80-watt hours per litre or more, 90-watt hours per litre or more, 100-watt hours per litre or more, 200-watt hours per litre or more, 300-watt hours per litre or more, 400-watt hours per litre or more, 500-watt hours per litre or more, 600-watt hours per litre or more, 700-watt hours per litre or more, 800-watt hours per litre or more, 900-watt hours per litre or more, 1,000-watt hours per litre or more, 1,100-watt hours per litre or more, 1,200-watt hours per litre or more, 1,300-watt hours per litre or more, 1,400-watt hours per litre or more, 1,500-watt hours per litre or more, 1,600-watt hours per litre or more, 1,700-watt hours per litre or more, 1,800-watt hours per litre or more, 1,900-watt hours per litre or more, 2,000-watt hours per litre or more, 2,100-watt hours per litre or more, 2,200-watt hours per litre or more, 2,300-watt hours per litre or more, 2,400-watt hours per litre or more, 2,500-watt hours per litre or more, 2,600-watt hours per litre or more, 2,700-watt hours per litre or more, 2,800-watt hours per litre or more, or 2,900-watt hours per litre or more.

For example, it is preferable that the liquid can be irradiated with UV-A light with an exposure of 100-watt hours per litre or lower, 200-watt hours per litre or lower, 300-watt hours per litre or lower, 400-watt hours per litre or lower, 500-watt hours per litre or lower, 600-watt hours per litre or lower, 700-watt hours per litre or lower, 800-watt hours per litre or lower, 900-watt hours per litre or lower, 1,000-watt hours per litre or lower, 1,100-watt hours per litre or lower, 1,200-watt hours per litre or lower, 1,300-watt hours per litre or lower, 1,400-watt hours per litre or lower, 1,500-watt hours per litre or lower, 1,600-watt hours per litre or lower, 1,700-watt hours per litre or lower, 1,800-watt hours per litre or lower, 1,900-watt hours per litre or lower, 2,000-watt hours per litre or lower, 2,100-watt hours per litre or lower, 2,200-watt hours per litre or lower, 2,300-watt hours per litre or lower, 2,400-watt hours per litre or lower, 2,500-watt hours per litre or lower, 2,600-watt hours per litre or lower, 2,700-watt hours per litre or lower, 2,800-watt hours per litre or lower, 2,900-watt hours per litre or lower, or 3,000-watt hours per litre or lower.

In certain embodiments, the UV-A light is provided at a dose of between 0.05 to 10 Watt hours per square inch, such as 0.1 Watt hours per square inch, 0.5 Watt hours per square inch, 1 Watt hours per square inch, 1.5 Watt hours per square inch, 2 Watt hours per square inch, 2.5 Watt hours per square inch, 3 Watt hours per square inch, 3.5 Watt hours per square inch, 4 Watt hours per square inch, 4.5 Watt hours per square inch, 5 Watt hours per square inch, 5.5 Watt hours per square inch, 6 Watt hours per square inch, 6.5 Watt hours per square inch, 7 Watt hours per square inch, 7.5 Watt hours per square inch, 8 Watt hours per square inch, 8.5 Watt hours per square inch, 9 Watt hours per square inch, 9.5 Watt hours per square inch, or 10 Watt hours per square inch.

In certain embodiments, the one or more sulfur-containing compounds can include di-methyl sulfide, hydrogen sulfide, and sulfur dioxide.

In certain embodiments, the initial total sulfur content is between 1 ppb and 70 ppb. In certain embodiments, the initial total sulfur content is 5 ppb, 10 ppb, 15 ppb, 20 ppb, 25 ppb, 30 ppb, 35 ppb, 40 ppb, 45 ppb, 50 ppb, 55 ppb, 60 ppb, 65 ppb, or 70 ppb. In certain embodiments, the initial total sulfur content is between 1 ppb and 200 ppb. In certain embodiments, the initial total sulfur content is 5 ppb, 10 ppb, 15 ppb, 20 ppb, 25 ppb, 30 ppb, 35 ppb, 40 ppb, 45 ppb, 50 ppb, 55 ppb, 60 ppb, 65 ppb, or 70 ppb. The total sulfur content means a content of sulfur-containing compounds in total. The total sulfur content can be measured by GC-FPD as explained in the Example section.

In certain embodiments, the initial total di-methyl sulfide content is between 1 ppb and 25 ppb. In certain embodiments, the initial total di-methyl sulfide content is between 1 ppb and 100 ppb. In certain embodiments, the initial total sulfur content is 1 ppb, 2 ppb, 3 ppb, 4 ppb, 5 ppb, 6 ppb, 7 ppb, 8 ppb, 9 ppb, 10 ppb, 15 ppb, 20 ppb, 25 ppb, 30 ppb, 35 ppb, 40 ppb, 45 ppb, 50 ppb, 55 ppb, 60 ppb, 65 ppb, 70 ppb, or 75 ppb.

In certain embodiments, the initial total hydrogen sulfide content is between 0.1 ppb and 25 ppb. In certain embodiments, the initial total hydrogen sulfide content is 0.3 ppb, 0.5 ppb, 0.7 ppb, 0.9 ppb, 1 ppb, 2 ppb, 3 ppb, 4 ppb, 5 ppb, 6 ppb, 7 ppb, 8 ppb, 9 ppb, 10 ppb, 15 ppb, 20 ppb, or 25 ppb. In certain embodiments, the initial total content of hydrogen sulfide and carbonyl sulfide is between 0.1 ppb and 25 ppb. In certain embodiments, the initial total content of hydrogen sulfide and carbonyl sulfide is 0.3 ppb, 0.5 ppb, 0.7 ppb, 0.9 ppb, 1 ppb, 2 ppb, 3 ppb, 4 ppb, 5 ppb, 6 ppb, 7 ppb, 8 ppb, 9 ppb, 10 ppb, 15 ppb, 20 ppb, or 25 ppb.

In certain embodiments, the initial total sulfur dioxide content is between 0.1 ppb and 25 ppb. In certain embodiments, the initial total sulfur dioxide content is 0.3 ppb, 0.5 ppb, 0.7 ppb, 0.9 ppb, 1 ppb, 2 ppb, 3 ppb, 4 ppb, 5 ppb, 6 ppb, 7 ppb, 8 ppb, 9 ppb, 10 ppb, 11 ppb, 12 ppb, 13 ppb, 14 ppb, 15 ppb, 16 ppb, 17 ppb, 18 ppb, 19 ppb, 20 ppb, 21 ppb, 22 ppb, 23 ppb, 24 ppb, or 25 ppb.

In certain embodiments, the beverage after the irradiation comprises between 0.5 ppb and 15 ppb of total sulfur content, such as 1 ppb, 2 ppb, 3 ppb, 4 ppb, 5 ppb, 6 ppb, 7 ppb, 8 ppb, 9 ppb, 10 ppb, 11 ppb, 12 ppb, 13 ppb, 14 ppb or 15 ppb of total sulfur content.

In certain embodiments, the beverage after the irradiation comprises between 0.1 ppb and 10 ppb of di-methyl sulfide, such as 0.2 ppb, 0.5 ppb, 0.7 ppb, 1 ppb, 2 ppb, 3 ppb, 4 ppb, 5 ppb, 6 ppb, 7 ppb, 8 ppb, 9 ppb, or 10 ppb of di-methyl sulfide.

In certain embodiments, the beverage after the irradiation comprises between 0.1 ppb and 20 ppb of hydrogen sulfide and/or carbonyl sulfide, such as 0.5 ppb, 0.7 ppb, 1 ppb, 2 ppb, 3 ppb, 4 ppb, 5 ppb, 6 ppb, 7 ppb, 8 ppb, 9 ppb, 10 ppb or 15 ppb of hydrogen sulfide and/or carbonyl sulfide.

In certain embodiments, the beverage after the irradiation comprises between 0.1 ppb and 10 ppb of sulfur dioxide, such as 0.5 ppb, 0.7 ppb, 1 ppb, 2 ppb, 3 ppb, 4 ppb, 5 ppb, 6 ppb, 7 ppb, 8 ppb, 9 ppb, or 10 ppb of sulfur dioxide.

In certain embodiments, the liquid is maintained at a temperature between 15° C. and 55° C. . . . In certain embodiment, the liquid is maintained at a temperature of 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., or 50° C.

In certain embodiments, the step of irradiation with UV-A light can be for a period of between 3 and 96 hours. In certain embodiments, the step of irradiation with UV-A light can be for a period of between 1 and 96 hours. The period of irradiation can be 3 hours, 5 hours, 8 hours, 10 hours, 12 hours, 14 hours, 16 hours, 18 hours, 20 hours, 22 hours, 24 hours, 26 hours, 28 hours, 30 hours, 32 hours, 34 hours, 36 hours, 38 hours, 40 hours, 42 hours, 44 hours, 46 hours, 48 hours, 50 hours, 52 hours, 54 hours, 56 hours, 58 hours, 60 hours, 62 hours, 64 hours, 66 hours, 68 hours, 70 hours, 72 hours, 74 hours, 76 hours, 78 hours, 80 hours, 82 hours, 84 hours, 86 hours, 88 hours, 90 hours, 92 hours, 94 hours, or 96 hours. The step of irradiation as specified above can be repeated. The duration and the temperature in the subsequent step(s) of the irradiation can be the same as or different from the first step of irradiation. The total durations of the steps of irradiation can be 150 hours, 200 hours, 300 hours, 500 hours, 1000 hours, 1500 hours, 2000 hours, 3000 hours, 4000 hours, or 5000 hours.

In certain embodiments, the total sulfur content of the liquid after the irradiation can be reduced into a range between 10% and 90% of the initial sulfur content. For example, the total sulfur content of the liquid after the irradiation is reduced to 12%, 14%, 16%, 18%, 20%, 22%, 24%, 26%, 28%, 30%, 32%, 34%, 36%, 38%, 40%, 42%, 44%, 46%, 48%, 50%, 52%, 54%, 56%, 58%, 60%, 62%, 64%, 66%, 68%, 70%, 72%, 74%, 76%, 78%, 80%, 82%, 84%, 86%, 88%, or 90% of the initial sulfur content.

In certain embodiments, the di-methyl sulfide content of the liquid after the irradiation can be reduced to a range between 10% and 90% of the initial di-methyl sulfide content. In certain embodiments, the di-methyl sulfide content of the liquid after the irradiation can be reduced to a range between 0.05% and 90% of the initial di-methyl sulfide content. For example, the di-methyl sulfide content of the liquid after the irradiation can be reduced into 0.05%, 1%, 2%, 3%, 5%, 7%, 10%, 12%, 14%, 16%, 18%, 20%, 22%, 24%, 26%, 28%, 30%, 32%, 34%, 36%, 38%, 40%, 42%, 44%, 46%, 48%, 50%, 52%, 54%, 56%, 58%, 60%, 62%, 64%, 66%, 68%, 70%, 72%, 74%, 76%, 78%, 80%, 82%, 84%, 86%, 88%, or 90% of the initial di-methyl sulfide content.

In certain embodiments, the hydrogen sulfide content of the liquid after the irradiation can be reduced to a range between 10% and 90% of the initial hydrogen sulfide content. For example, the hydrogen sulfide content of the liquid after the irradiation can be reduced to 12%, 14%, 16%, 18%, 20%, 22%, 24%, 26%, 28%, 30%, 32%, 34%, 36%, 38%, 40%, 42%, 44%, 46%, 48%, 50%, 52%, 54%, 56%, 58%, 60%, 62%, 64%, 66%, 68%, 70%, 72%, 74%, 76%, 78%, 80%, 82%, 84%, 86%, 88%, or 90% of the initial hydrogen sulfide content.

In certain embodiments, the sulfur dioxide content of the liquid after the irradiation can be reduced to between 10% and 90% of the initial sulfur dioxide content. For example, the sulfur dioxide content of the liquid after the irradiation can be reduced 12%, 14%, 16%, 18%, 20%, 22%, 24%, 26%, 28%, 30%, 32%, 34%, 36%, 38%, 40%, 42%, 44%, 46%, 48%, 50%, 52%, 54%, 56%, 58%, 60%, 62%, 64%, 66%, 68%, 70%, 72%, 74%, 76%, 78%, 80%, 82%, 84%, 86%, 88%, or 90% of the initial sulfur dioxide content.

In certain embodiments, the flavorant comprises charred and/or toasted oak staves having a surface to volume ratio of between 45 to 95 square inches per gallon of liquid. In some embodiments, the flavor is chosen from natural wood tones, vanilla, caramelized tones, smoky or smooth tones.

In certain embodiment, after the liquid is maintained at a temperature of between 20° C. and 50° C. and irradiated with UV-A light for a period of between 6 hours to 96 hours, the beverage comprises 10% to 90% less sulfur dioxide than the initial sulfur dioxide content. In certain embodiment, after the liquid is maintained at a temperature of between 20° C. and 50° C. and irradiated with UV-A light for a period of between 1 hours to 96 hours, the beverage comprises 10% to 90% less sulfur dioxide than the initial sulfur dioxide content. In some embodiments, the beverage comprises 12% less sulfur dioxide than the initial sulfur dioxide content, 14% less sulfur dioxide than the initial sulfur dioxide content, 16% less sulfur dioxide than the initial sulfur dioxide content, 18% less sulfur dioxide than the initial sulfur dioxide content, 20% less sulfur dioxide than the initial sulfur dioxide content, 22% less sulfur dioxide than the initial sulfur dioxide content, 24% less sulfur dioxide than the initial sulfur dioxide content, 26% less sulfur dioxide than the initial sulfur dioxide content, 28% less sulfur dioxide than the initial sulfur dioxide content, 30% less sulfur dioxide than the initial sulfur dioxide content, 32% less sulfur dioxide than the initial sulfur dioxide content, 34% less sulfur dioxide than the initial sulfur dioxide content, 36% less sulfur dioxide than the initial sulfur dioxide content, 38% less sulfur dioxide than the initial sulfur dioxide content, 40% less sulfur dioxide than the initial sulfur dioxide content, 42% less sulfur dioxide than the initial sulfur dioxide content, 44% less sulfur dioxide than the initial sulfur dioxide content, 46% less sulfur dioxide than the initial sulfur dioxide content, 48% less sulfur dioxide than the initial sulfur dioxide content, 50% less sulfur dioxide than the initial sulfur dioxide content, 52% less sulfur dioxide than the initial sulfur dioxide content, 54% less sulfur dioxide than the initial sulfur dioxide content, 56% less sulfur dioxide than the initial sulfur dioxide content, 58% less sulfur dioxide than the initial sulfur dioxide content, 60% less sulfur dioxide than the initial sulfur dioxide content, 62% less sulfur dioxide than the initial sulfur dioxide content, 64% less sulfur dioxide than the initial sulfur dioxide content, 66% less sulfur dioxide than the initial sulfur dioxide content, 68% less sulfur dioxide than the initial sulfur dioxide content, 70% less sulfur dioxide than the initial sulfur dioxide content, 72% less sulfur dioxide than the initial sulfur dioxide content, 74% less sulfur dioxide than the initial sulfur dioxide content, 76% less sulfur dioxide than the initial sulfur dioxide content, 78% less sulfur dioxide than the initial sulfur dioxide content, 80% less sulfur dioxide than the initial sulfur dioxide content, 82% less sulfur dioxide than the initial sulfur dioxide content, 84% less sulfur dioxide than the initial sulfur dioxide content, 86% less sulfur dioxide than the initial sulfur dioxide content, 88% less sulfur dioxide than the initial sulfur dioxide content, 90% less sulfur dioxide than the initial sulfur dioxide content, 92% less sulfur dioxide than the initial sulfur dioxide content, 94% less sulfur dioxide than the initial sulfur dioxide content, 96% less sulfur dioxide than the initial sulfur dioxide content.

In some embodiments, after the liquid is maintained at a temperature of between 20° C. and 50° C. and irradiated with UV-A light for a period of between 1 hours to 96 hours, the beverage comprises 12% less di-methyl sulfide than the initial di-methyl sulfide content, 14% less di-methyl sulfide than the initial di-methyl sulfide content, 16% less di-methyl sulfide than the initial di-methyl sulfide content, 18% less di-methyl sulfide than the initial di-methyl sulfide content, 20% less di-methyl sulfide than the initial di-methyl sulfide content, 22% less di-methyl sulfide than the initial di-methyl sulfide content, 24% less di-methyl sulfide than the initial di-methyl sulfide content, 26% less di-methyl sulfide than the initial sulfur dioxide content, 28% less di-methyl sulfide than the initial di-methyl sulfide content, 30% less di-methyl sulfide than the initial di-methyl sulfide content, 32% less di-methyl sulfide than the initial di-methyl sulfide content, 34% less di-methyl sulfide than the initial di-methyl sulfide content, 36% less di-methyl sulfide than the initial di-methyl sulfide content, 38% less di-methyl sulfide than the initial di-methyl sulfide content, 40% less di-methyl sulfide than the initial di-methyl sulfide content, 42% less di-methyl sulfide than the initial di-methyl sulfide content, 44% less di-methyl sulfide than the initial di-methyl sulfide content, 46% less di-methyl sulfide than the initial di-methyl sulfide content, 48% less di-methyl sulfide than the initial di-methyl sulfide content, 50% less di-methyl sulfide than the initial di-methyl sulfide content, 52% less di-methyl sulfide than the initial di-methyl sulfide content, 54% less di-methyl sulfide than the initial di-methyl sulfide content, 56% less di-methyl sulfide than the initial di-methyl sulfide content, 58% less di-methyl sulfide than the initial di-methyl sulfide content, 60% less di-methyl sulfide than the initial di-methyl sulfide content, 62% less di-methyl sulfide than the initial di-methyl sulfide content, 64% less di-methyl sulfide than the initial di-methyl sulfide content, 66% less di-methyl sulfide than the initial di-methyl sulfide content, 68% less di-methyl sulfide than the initial di-methyl sulfide content, 70% less di-methyl sulfide than the initial di-methyl sulfide content, 72% less di-methyl sulfide than the initial di-methyl sulfide content, 74% less di-methyl sulfide than the initial di-methyl sulfide content, 76% less di-methyl sulfide than the initial di-methyl sulfide content, 78% less di-methyl sulfide than the initial di-methyl sulfide content, 80% less di-methyl sulfide than the initial di-methyl sulfide content, 82% less di-methyl sulfide than the initial di-methyl sulfide content, 84% less di-methyl sulfide than the initial di-methyl sulfide content, 86% less di-methyl sulfide than the initial di-methyl sulfide content, 88% less di-methyl sulfide than the initial di-methyl sulfide content, 90% less di-methyl sulfide than the initial di-methyl sulfide content, 92% less di-methyl sulfide than the initial di-methyl sulfide content, 94% less di-methyl sulfide than the initial di-methyl sulfide content, 96% less di-methyl sulfide than the initial di-methyl sulfide content.

In some embodiments, after the liquid is maintained at a temperature of between 15° C. and 55° C. and irradiated with UV-A light for a period of between 3 hours to 96 hours, the beverage can maintain its sulfur content of 10% to 90% less sulfur dioxide than the initial sulfur dioxide content for 1 month to 20 years. In some embodiments, after the liquid is maintained at a temperature of between 15° C. and 55° C. and irradiated with UV-A light for a period of between 1 hours to 96 hours, the beverage can maintain its sulfur content of 10% to 90% less sulfur dioxide than the initial sulfur dioxide content for 1 month to 20 years. For example, the beverage can maintain its sulfur content of 10% to 90% less sulfur dioxide than the initial sulfur dioxide content for 2 months, 3 months, 4 months, 5 months, 6 months, 7 months, 8 months, 9 months, 10 months, 11 months, 12 months, 13 months, 14 months, 15 months, 16 months, 17 months, 18 months, 19 months, 20 months, 21 months, 22 months, 23 months, 24 months, 2.5 years, 3 years, 3.5 years, 4 years, 4.5 years, 5 years, 5.5 years, 6 years, 6.5 years, 7 years, 7.5 years, 8 years, 8.5 years, 9 years, 9.5 years, 10 years, 10.5 years, 11 years, 11.5 years, 12 years, 12.5 years, 13 years, 13.5 years, 14 years, 14.5 years, 15 years, 15.5 years, 16 years, 16.5 years, 17 years, 17.5 years, 18 years, 18.5 years, 19 years, 19.5 years, or 20 years.

In certain embodiments, the beverage can be made quicker than the conventional methods. For example, the beverage can be made 1 day to 6 months. For example, the beverage can be made 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 22 days, 23 days, 24 days, 25 days, 26 days, 27 days, 28 days, 29 days, 30 days, 1 month, 1.5 months, 2 months, 2.5 months, 3 months, 3.5 months, 4 months, 4.5 months, 5 months, 5.5 months, or 6 months.

In certain embodiments, the liquid can be irradiated with other forms of UV light, such as UV-B light or UV-C light. For example, a UV-A light having a wavelength of 315 to 400 nm, more preferably, 315 to 395 nm, yet more preferably, 350 to 395 nm can be preferably used; a UV-B light having a wavelength of 280 to 315 nm, more preferably, 290 to 315 nm, yet more preferably, 300 to 315 nm can be preferably used; and a UV-C light having a wavelength of 100 to 280 nm, more preferably, 150 to 280 nm, yet more preferably, 200 to 280 nm can be preferably used.

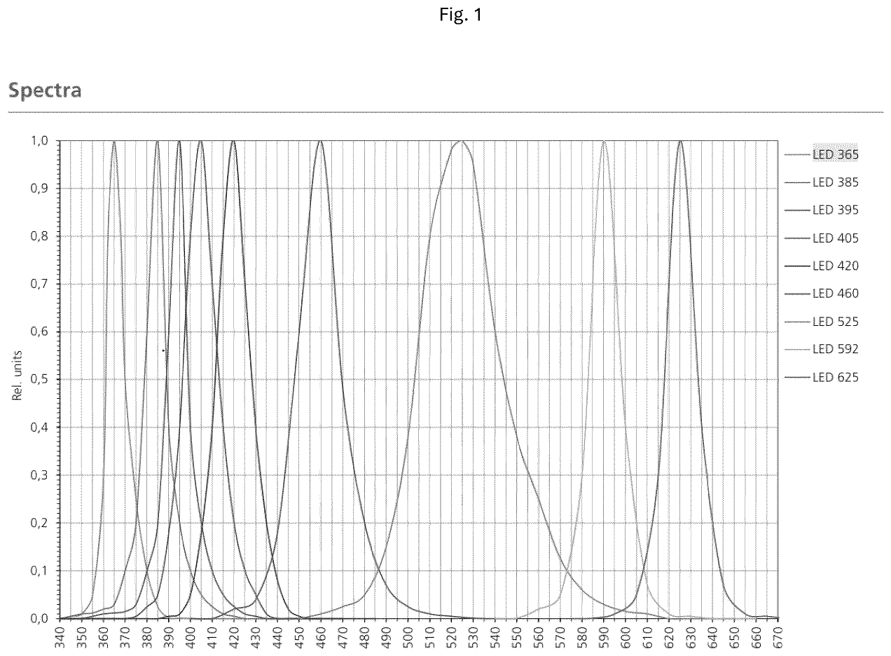

FIG. 1 shows various spectrum. Among the spectrum shown in FIG. 1, the UV light having a peak at 365 nm, 385 nm and/or 395 nm can be preferably used.

In certain embodiments, the beverage after the irradiation can be stored in a bottle with a final volume of 50 mL to 1750 mL, such as 200 mL, 350 mL, 750 mL, 1000 mL or 1750 mL.

In certain embodiments, the final beverage contains less than 15 ppb of sulfur-containing compounds for up to 50 years. In certain embodiments, the final beverage contains less than 15 ppb of sulfur-containing compounds, less than 14 ppb of sulfur-containing compounds, less than 13 ppb of sulfur-containing compounds, less than 12 ppb of sulfur-containing compounds, less than 11 ppb of sulfur-containing compounds, less than 10 ppb of sulfur-containing compounds, less than 9 ppb of sulfur-containing compounds, less than 8 ppb of sulfur-containing compounds, less than 7 ppb of sulfur-containing compounds, less than 6 ppb of sulfur-containing compounds, less than 5 ppb of sulfur-containing compounds, less than 4 ppb of sulfur-containing compounds, less than 3 ppb of sulfur-containing compounds, less than 2 ppb of sulfur-containing compounds, or less than 1 ppb of sulfur-containing compounds. In certain embodiments, the final beverage maintains a level of less than 15 ppb of sulfur-containing compounds for up to 5 years, 10 years, 15 years, 20 years, 25 years, 30 years, 35 years, 40 years, 45 years, 50 years.

### Example 1

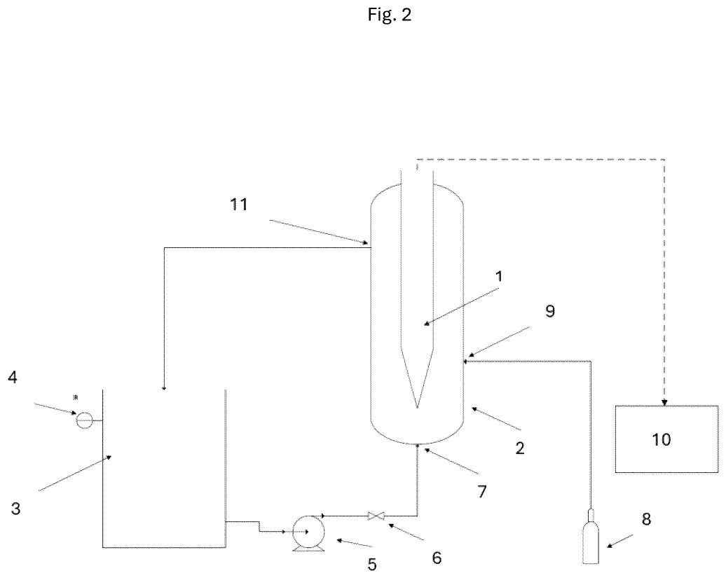

FIG. 2 illustrates a system for carrying out the process described in this application. The liquid obtained by distillation of the grain raw materials is held in tank 3, in which temperature transmitter 4 monitors the temperature inside. The liquid is supplied from tank 3 to flow reactor 2 via pump 5, flow control valve 6 and liquid inlet 7. Gases are supplied from gas supply 8 and gas inlet 9 provided on flow reactor 2. UV light source 1 is inserted in flow reactor 2. The UV light from UV light source 1 is controlled by UV controller 10. Flow reactor 2 has liquid outlet 11 which is connected to tank 3. The liquid processed in flow reactor 2 is returned to tank 1 in a recirculating loop in FIG. 2. This process is repeated until sufficient UV exposure has done to accomplish the intended results, such as sufficiently reducing the sulfur content.

### Example 2

A liquid was provided through a fermentation process using cereal grains as raw materials. The liquid was further distilled to obtain distillate with 67.5% as alcohol degree. Samples of distillate were collected from the production process and transferred to six 100 mL PET bottles. The width and height of the bottle used were 12.7 cm and 5.08 cm. The exposure area of the bottle was 64.52 cm². Five of the 100 ml bottles of distillate were then placed under six Phillips TL Blacklight Blue UVA lamps having a peak wavelength of 365 nm with an average total intensity of 25 Whr/m² and exposed at 35° C. The sixth bottle was retained as a control sample and stored in a dark location at room temperature. Bottles were removed from UVA exposure at 8 hours, 24 hours, 32 hours, 48 hours, and 56 hours. The samples were evaluated within one day of completion of the UVA exposure due to the volatile nature of the sulfur containing compounds. For example, when the bottles were removed from UVA exposure at 8 hours, the exposure by volume rate and the exposure by volume can be calculated as follows:

$$Exposure by volume rate = ( 25 Whr / {m}^{2} ) \times ( 0.006452 {m}^{2} ) / ( 0.1 litre ) = 1.613 Whr / litre$$

$$Exposure by volume = ( 1.613 Whr / litre ) \times ( 8 hr ) = 12.9 W / litre$$

Samples of differing exposure times of UV treated distillate were analyzed to identify and quantify sulfur compounds. Sensory testing showed a reduction of undesirable aromatics under UV treatment. The first analysis pointed towards sulfur compounds being the main cause for sensory differences between UV treated and non-UV treated distillate.

The reduction of di-methyl sulfide (DMS), the reduction of hydrogen sulfide (HS) and carbonyl sulfide (COS) in the liquid with the exposure were investigated. DMS accounts for 70% of the total sulfur content and degrades by 85% after 8 hours of the UV exposure. Ideal sensory conditions such as a significant improvement of the flavors were achieved after 32 hours of exposure. It is likely other compounds are breaking down due to the UV exposure.

TABLE 1
Total Sulfur and Di-Methyl Sulfide Content in
Spirits at 8 Hours, 24 Hours, and 32 Hours.

| Parameter | Liquid Control | 8 hour | 24 hour | 32 hour |
|---|---|---|---|---|
| Dimethyl Sulfide (DMS) | 5.7 | 0.7 | 0.7 | 0.8 |
| (ppb) | | | | |
| Hydrogen Sulfide (HS) & | 4.3 | 2.1 | 2.1 | 2.2 |
| Carbonyl Sulfide (COS) | | | | |
| (ppb) | | | | |
| Total Sulfur (ppbrelative to | 10.3 | 2.9 | 3.0 | 3.1 |
| standard DMS) | | | | |

The liquid was treated under UV light for different lengths of time. This was done in the hope that analytical testing could help understand why there are sensory differences between the control and samples. Samples were treated for 8, 24, 32, 48 and 56 hours. Quick analysis time was important for these samples due to the extremely volatile nature of some sulfur compounds.

Analysis was performed on an Agilent 8890 GC using an FPD detector using 30 m Zebron ZB-1 column with 0.32 mm diameter and 3.00 um film thickness. Samples were analyzed by headspace solid phase micro extraction (SPME) using a carboxen/PDMS fiber. Samples were prepared in 20 mL vials with a 1:10 dilution with DI water. Sulfur content was determined by using a semi-quantitative method with DMS as an internal standard.

There was a moderate sensory difference between the control and the sample treated for 8 hours. There was a significant sensory difference between the control and the 24 hour sample. The 32 hour sample was only slightly different than the 24 hour sample but was considered the completely clean sample in this analysis. Samples 48 hour and 56 hour had very similar sensory profiles to the 32 hour sample.

Sulfur was run by using GC-FPD on a ZB-1 column using a SPME black fiber (carboxen/PDMS). One compound accounted for ˜70% of difference in total sulfur content between the control liquid and UV treated liquid. This compound was identified to be dimethyl sulfide (DMS@2.25 minutes) which is known to form during brewing. It has a cooked cabbage or cooked corn aroma. Concentrations of DMS were calculated by spiking samples with a known concentration. Also, concentrations of HS and COS were calculated by spiking samples with a known concentration. All other concentrations were calculated from DMS.

This analysis showed that DMS accounts for the majority of total sulfur content in the liquid samples and decreases by 85% after 8 hours of UV treatment. There is no significant differences in total sulfur content or DMS content between the 8 hour, 24 hour, and 32 hour samples. This analysis showed a total decrease of up to 70% in total sulfur content.

The FPD analysis performed on these samples showed that almost all of the total sulfur and DMS content degrade after 8 hours. In addition, the sensory analysis showed that where it took 32 hours for samples to smell clean.

### Example 3

A liquid was prepared in the same manner as Example 2, and the bottles including the liquid were treated with the UVA in the same manner as Example 2, except for changing the duration of the irradiation. That it, the bottles were removed from UVA exposure at 3 hours and 5 hours in Example 3. Then, the sulfur contents were measured and the sensory tests were carried out in the same manner as Example 2.

The results are shown in Table 2.

TABLE 2

| Parameter | Liquid Control | 3 hour | 5 hour |
|---|---|---|---|
| Dimethyl Sulfide (ppb) | 50.7 | 7.2 | 0.3 |
| Hydrogen Sulfide (HS) & Carbonyl | 11.0 | 6.5 | 5.8 |
| Sulfide (COS) (ppb) | | | |
| Total Sulfur (ppb relative to | 63.5 | 14.0 | 12.4 |
| standard DMS) | | | |

From a brief sensory evaluation by a group of inventors, it was found that there was a sensory improvement between the liquid control and the UV treated distillate (3 hours and 5 hours).

All references cited herein are hereby incorporated by reference. The detailed description set forth above is provided to aid those skilled in the art in practicing the present disclosure. However, the disclosure described and claimed herein is not to be limited in scope by the specific embodiments herein disclosed because these embodiments are intended as illustration of several aspects of the disclosure. Any equivalent embodiments are intended to be within the scope of this disclosure. Indeed, various modifications of the disclosure in addition to those shown and described herein will become apparent to those skilled in the art from the foregoing description, which do not depart from the spirit or scope of the present inventive discovery. Such modifications are also intended to fall within the scope of the appended claims.

### Exemplary Embodiments

The present invention may encompass the following listing of exemplary embodiments:
Embodiment 1. A method of making a beverage, comprising:
providing a liquid through a fermentation process; and
irradiating the liquid with a light with a dose of 1-watt hours per litre to 3,000-watt hours per litre for 3 hours to 96 hours at a temperature of between 15° C. and 55° C.
Embodiment 2. The method of embodiment 1, wherein the light has an energy peak at a wavelength between 315 nm and 400 nm.
Embodiment 3. The method of embodiment 1 or 2, wherein the liquid was distilled after the fermentation process.
Embodiment 4. The method of any one of embodiments 1 to 3, wherein the light is a UV-A light.
Embodiment 5. The method of any one of embodiments 1 to 4, wherein the light is a UV-A light and the liquid is irradiated for 8 hours to 56 hours.
Embodiment 6. The method of any one of embodiments 1 to 5, wherein after irradiating the liquid, a total sulfur content of the liquid is between 10% and 90% of an initial total sulfur content of the liquid.
Embodiment 7. The method of any one of embodiments 1 to 6, wherein the light is irradiated at a dose of between about 0.05 to about 10 Watt hours per square inch.
Embodiment 8. The method of any one of embodiments 1 to 7, wherein the beverage comprises a sulfur-containing compound selected from the group consisting of di-methyl sulfide, hydrogen sulfide, carbonyl sulfide and sulfur dioxide.
Embodiment 9. The method of embodiment 6, wherein the flavored beverage comprises less than 3 ppb of di-methyl sulfide.
Embodiment 10. The method of embodiment 6, wherein the flavored beverage comprises less than 2 ppb of di-methyl sulfide.
Embodiment 11. The method of embodiment 6, wherein the flavored beverage comprises less than 1 ppb of di-methyl sulfide.
Embodiment 12. The method of embodiment 6, wherein the flavored beverage comprises less than 5 ppb of a total sulfur content.
Embodiment 13. The method of embodiment 6, wherein the flavored beverage comprises less than 3.5 ppb of a total sulfur content.
Embodiment. 14 The method of any one of embodiments 1 to 13, wherein after irradiating the liquid, a total sulfur content of the liquid is between 10% and 60%, between 14% and 50%, or between 16% and 40%, of an initial total sulfur content of the liquid.
Embodiment 15. The method of any one of embodiments 1 to 14, wherein the liquid is irradiated with a light with a dose of 1-watt hours per litre to 1,000-watt hours per litre, 5-watt hours per litre to 500-watt hours per litre, or 30-watt hours per litre to 200-watt hours per litre.
Embodiment. 16 The method of any one of embodiments 1 to 15, wherein the light is a UV-A light and the liquid is irradiated for 12 hours to 56 hours, or 24 hours to 48 hours.
Embodiment. 17 The method of any one of embodiments 1 to 16, wherein the light has an energy peak at a wavelength between 315 nm and 395 nm, or between 315 nm and 385 nm.

What is claimed is:

1. A method of making a beverage, comprising:
providing a liquid through a fermentation process; and
irradiating the liquid with a light with a dose of 1-watt hours per litre to 3,000-watt hours per litre for 1 hour to 96 hours at a temperature of between 15° C. and 55° C.

2. The method of claim 1, wherein the light has an energy peak at a wavelength between 315 nm and 400 nm.

3. The method of claim 1, wherein the liquid was distilled after the fermentation process.

4. The method of claim 1, wherein the light is a UV-A light.

5. The method of claim 1, wherein the light is a UV-A light and the liquid is irradiated for 8 hours to 56 hours.

6. The method of claim 1, wherein after irradiating the liquid, a total sulfur content of the liquid is between 10% and 90% of an initial total sulfur content of the liquid.

7. The method of claim 1, wherein the light is irradiated at a dose of between about 0.05 to about 10 Watt hours per square inch.

8. The method of claim 1, wherein the beverage comprises a sulfur-containing compound selected from the group consisting of di-methyl sulfide, hydrogen sulfide, carbonyl sulfide and sulfur dioxide.

9. The method of claim 6, wherein the flavored beverage comprises less than 3 ppb of di-methyl sulfide.

10. The method of claim 6, wherein the flavored beverage comprises less than 2 ppb of di-methyl sulfide.

11. The method of claim 6, wherein the flavored beverage comprises less than 1 ppb of di-methyl sulfide.

12. The method of claim 6, wherein the flavored beverage comprises less than 5 ppb of a total sulfur content.

13. The method of claim 6, wherein the flavored beverage comprises less than 3.5 ppb of a total sulfur content.
